(19) United States
(12) Patent Application Publication
(10) Pub. No.: US 2025/0140940 A1
(43) Pub. Date: May 1, 2025

(54) Flame-Resistant Solid-State Batteries and Manufacturing Method

(71) Applicant: Honeycomb Battery Company, Dayton, OH (US)

(72) Inventors: Kailash Patil, Dayton, OH (US); Song-Hai Chai, Dayton, OH (US); Hao-Hsun Chang, Centerville, OH (US); Bor Z. Jang, Centerville, OH (US)

(73) Assignee: Honeycomb Battery Company, Dayton, OH (US)

(21) Appl. No.: 18/494,415

(22) Filed: Oct. 25, 2023

(51) Int. Cl. H01M 10/42; H01M 4/02; H01M 4/131; H01M 4/133; H01M 4/62; H01M 10/052; H01M 10/0525; H01M 10/056; H01M 10/0562; H01M 10/0565

(52) U.S. Cl. CPC H01M 10/4235; H01M 4/131; H01M 4/133; H01M 4/62; H01M 10/052; H01M 10/0525; H01M 10/056; H01M 10/0562; H01M 10/0565; H01M 2004/027; H01M 2004/028; H01M 2300/0071; H01M 2300/0082; H01M 2300/0091; H01M 2300/0094

(57) ABSTRACT

A lithium battery comprising an anode, a cathode, a solid-state electrolyte, an interface enhancer composition in ionic communication with the anode and the cathode, wherein (a) the electrolyte comprises a solid polymer, a polymer gel, an inorganic solid-state, or a polymer/inorganic composite electrolyte; (b) the interface enhancer composition comprises a lithium salt, a liquid solution comprising an organic solvent or ionic liquid and a lithium salt dissolved therein, a polymer containing a lithium salt dissolved or dispersed therein, or a combination thereof; (c) the cathode comprises a cathode active layer comprising particles of a cathode active material, a conductive additive, an optional binder, and pores occupying 1% to 40% by volume of the cathode active layer and the interface enhancer resides in 30% to 100% of the pores; and (d) the interface enhancer is present between the solid-state electrolyte and the cathode and between the solid-state electrolyte and the anode.

### FIELD

The present invention provides a flame-resistant lithium battery (lithium-ion and lithium metal batteries) and method of manufacturing such a battery.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the liquid electrolytes used for all lithium-ion batteries and lithium metal secondary batteries pose some safety concerns. Most of the organic liquid electrolytes are not resistant to thermal runaway or explosion problems.

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li—S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Furthermore, ILs remain extremely expensive. Consequently, as of today, no commercially available lithium battery makes use of an ionic liquid as the primary electrolyte component.

Solid state electrolytes are commonly believed to be safe in terms of fire and explosion proof. Solid state electrolytes can be divided into organic, inorganic, organic-inorganic composite electrolytes. However, the conductivity of organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (about 10⁻⁴ to 10⁻² S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured. Although an organic-inorganic composite electrolyte can lead to a reduced interfacial resistance, the lithium ion conductivity and working voltages may be decreased due to the addition of certain organic polymers.

The applicant's research group has previously developed the quasi-solid state electrolytes (QSSE), which may be considered as a fourth type of solid state electrolyte. In certain variants of the quasi-solid state electrolytes, a small amount of liquid electrolyte may be present to help improving the physical and ionic contact between the electrolyte and the electrode, thus reducing the interfacial resistance. Examples of QSSEs are disclosed in the following: Hui He, et al. “Lithium Secondary Batteries Containing a Non-flammable Quasi-solid Electrolyte,” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

However, the presence of an excessive amount of certain types of liquid electrolytes may cause some problems, such as liquid leakage, gassing, and low resistance to high temperature if the cells are not properly handled. Therefore, a novel lithium-ion transport pathway strategy that obviates all or most of these issues is needed.

Hence, a general object of the present invention is to provide a safe, flame/fire-resistant rechargeable lithium cell that does not require a significant modification to the current battery production facilities. Such a novel approach enables the solid-state batteries to have the fastest time to market as compared to other solid-state batteries being developed.

### SUMMARY

The present disclosure provides a rechargeable lithium battery comprising an anode, a cathode, a solid-state electrolyte disposed between the anode and the cathode, at least an interface enhancer composition in ionic communication with the anode and the cathode, and an optional porous polymer separator, wherein: (a) the solid-state electrolyte comprises a solid polymer electrolyte, a polymer gel electrolyte, an inorganic solid-state electrolyte, or a polymer/inorganic composite electrolyte, wherein the solid-state electrolyte has a lithium-ion conductivity no less than 10⁻⁶ S/cm, preferably from 10⁻⁵ to 3.5×10⁻² S/cm; (b) the interface enhancer composition comprises a lithium salt, a liquid solution comprising an organic solvent or ionic liquid and a lithium salt (0.1% to 50% by weight) dissolved or dispersed therein, a polymer containing a lithium salt (0.1% to 50% by weight) dissolved or dispersed therein, or a combination thereof (e.g., a polymer containing a lithium salt and an ionic liquid or organic solvent dispersed therein); (c) the cathode comprises a cathode active layer comprising particles of a cathode active material, a conductive additive, an optional binder, and pores occupying 1% to 40% by volume of the cathode active layer and the interface enhancer resides in 30% to 100% of the pores; and (d) a first interface enhancer composition is present between the solid-state electrolyte and the cathode and a second interface enhancer composition is present between the solid-state electrolyte and the anode, wherein the first is identical to or different from the second interface enhancer composition.

The disclosed battery can function well with or without this optional porous polymer separator; e.g., porous polyethylene (PE), polypropylene (PP), PE/PP copolymer membrane, etc. The solid-state electrolyte disposed between the anode and the cathode serves effectively as a separator that electronically isolates the anode from the cathode. The solid-state electrolyte can have pores to accommodate the interface enhancer composition or can be pore-free provided that it has a lithium-ion conductivity greater than 10⁻⁶ S/cm (preferably from 10⁻⁵ S/cm to 3.5×10⁻² S/cm).

In certain embodiments, the anode comprises an anode active layer comprising particles of an anode active material, a conductive additive, an optional binder, and pores occupying 1% to 40% by volume of the anode active layer and the interface enhancer resides in 30% to 100% of the pores.

In some embodiments, the anode comprises initially an anode current collector only (i.e. a so-called “anode-less lithium cell”) or comprises a lithium metal or lithium alloy layer supported on an anode current collector (e.g., a lithium metal cell).

In some preferred embodiments, the interface enhancer composition or the solid-state electrolyte further comprises a flame retardant additive. The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

In certain desirable embodiments, the interface enhancer composition forms a contiguous phase or a continuous lithium ion pathway from the cathode active material through the solid-state electrolyte to the anode and the interface enhancer composition is in physical contact with substantially all particles of the cathode active material and all anode active material.

In a highly desirable embodiment, the interface enhancer composition comprises a lithium salt or a liquid solution comprising an ionic liquid (or an organic solvent) and a lithium salt dissolved or dispersed therein, and wherein the interface enhancer composition forms a contiguous phase or a continuous lithium ion pathway from the cathode active material through the solid-state electrolyte to the anode.

In some embodiments, the ionic liquid in the interface enhancer composition is selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI](n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylirmidazoliurm bis(trifluoromethylsulfonyl)imide ([EMIM][IFSI]). 1-Ethyl-3-methylimidazolium trifluoronmethanesulfonate ([EMIM][Tf]) and 1-Butyl-3-methylimidazolium dicyanamide ([BMIM][DCA]), or a combination thereof.

The ionic liquid in the interface enhancer composition may be selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

In certain embodiments, the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof. Preferably, the liquid or the polymer in the interface enhancer composition comprises a lithium salt of 0.1%-50% by weight dispersed therein.

Most of these liquids are polymerizable or cross-linkable; e.g., those organic compounds containing unsaturated C═C bonds, cyclic carbonates, cyclic esters, cyclic ethers, and combinations thereof. In the lithium-ion battery or lithium metal battery industry, the liquid solvents listed above are commonly used as a solvent to dissolve a lithium salt therein and the resulting solutions are used as a liquid electrolyte. It is uniquely advantageous to be able to polymerize the liquid solvent once injected into an anode, a cathode, a solid-state electrolyte, or a battery cell, enabling the formation of a contiguous lithium salt-containing solid polymer phase. With such a novel strategy, one can readily reduce the liquid solvent or completely eliminate the liquid solvent all together. This is of significant utility value since most of the organic solvents are known to be volatile and flammable, posing a fire and explosion danger.

Desirable liquid solvents include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

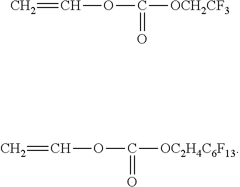

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

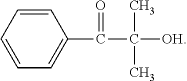

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively are shown below:

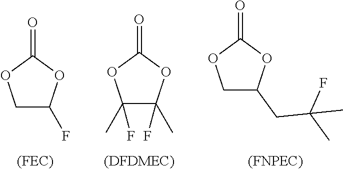

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

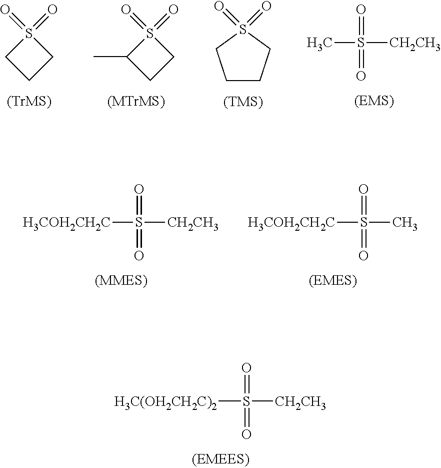

The cyclic structure, such as TrMS, MTrMS, and TMS, can be polymerized via ring-opening polymerization with the assistance of an ionic type initiator.

The nitrile may be selected from dinitriles, such as AND, GLN, SEN and SN, which have the following chemical formulae:

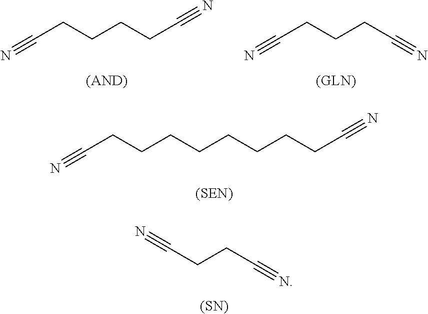

In some embodiments, the phosphate, phosphonate, phosphazene, phosphite, or sulfate is selected from tris(trimethylsilyl)phosphite (TTSPi), alkyl phosphate, triallyl phosphate (TAP), ethylene sulfate (DTD), a combination thereof. The phosphate, alkyl phosphonate, or phosphazene may be selected from the following:

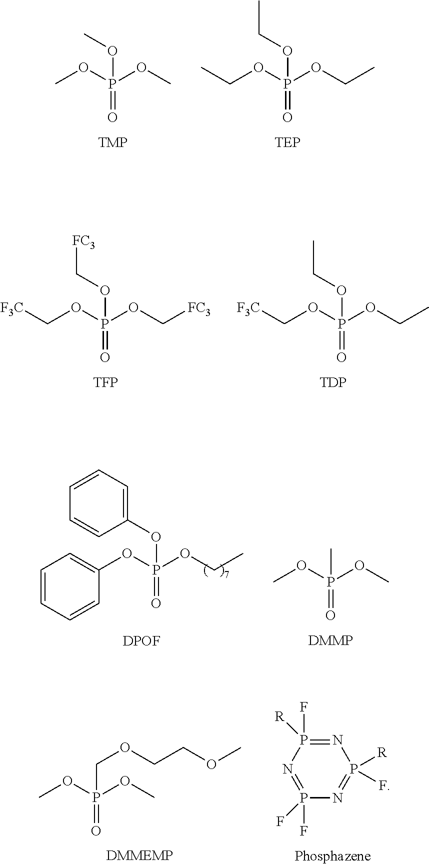

The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

Examples of a polymerizable phosphazene contain derivatives with a general structural formula:

[—NP(A)ₐ(B)_{b}-]ₓ

wherein the groups A and B are bonded to phosphorus atoms through —O—, —S—, —NH—, or —NR— (with R═C₁-C₆) alkyl), and wherein A stands more precisely for a vinyl ether group or a styrene ether group, and B stands more precisely for a hydrocarbon group. In general, A contains at least one vinyl ether group of the general formula Q-O—CR′═CHR″ and/or styrene ether group of the general formula:

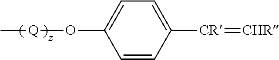

wherein R and/or R″ stands for hydrogen or C₁-C₁₀ alkyl; B stands for a reactive or nonreactive hydrocarbon group optionally containing O, S, and/or N and optionally containing at least one reactive group: Q is an aliphatic, cycloaliphatic, aromatic, and/or heterocyclic hydrocarbon group, optionally containing O, S, and/or N: a is a number greater than 0; b is 0 or a number greater than 0 and a+b=2; x stands for a whole number that is at least 2; and z stands for 0 or 1. Initiators for these phosphazene derivatives can be those of Lewis acids, SbCl₃, AlCl₃, or sulfur compounds.

The siloxane or silane may be selected from alkylsiloxane (Si—O), alkyylsilane (Si—C), liquid oligomeric silaxane (—Si—O—Si—), or a combination thereof.

In the disclosed lithium battery, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

In certain desirable embodiments, the inorganic solid-state electrolyte or the polymer/inorganic composite electrolyte comprises an inorganic solid electrolyte material selected from an oxide type, sulfide type, hydride type, halide type, halogen-modified sulfide type, borate type, phosphate type, lithium phosphorus oxynitride (LiPON), garnet-type, lithium superionic conductor (LISICON) type, sodium superionic conductor (NASICON) type, or a combination thereof.

In some embodiments, the polymer/inorganic composite electrolyte comprises particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The solid-state electrolyte may comprise a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphite, polyphosphonate, polyphosphazenes, polytetrahydrofuran, a copolymer thereof, a semi-penetrating network thereof, a sulfonated derivative thereof, or a combination thereof.

The present disclosure further provides a rechargeable lithium battery, including a lithium metal secondary cell, a lithium-ion cell, a lithium-sulfur cell, a lithium-ion sulfur cell, a lithium-selenium cell, or a lithium-air cell. This battery features a non-flammable, safe, and high-performing electrolyte as herein disclosed.

For a lithium metal cell (where lithium metal is the primary active anode material), the anode current collector may comprise a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

There is no limitation on what type of cathode active materials that can be used to practice the present disclosure. As some non-limiting examples, the cathode may comprise a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The present disclosure also provides a method of producing the disclosed rechargeable lithium cell, the method comprising: (a) Preparing a cathode comprising a cathode active layer optionally supported on a cathode current collector, wherein the cathode active layer comprises particles of a cathode active material, a conductive additive, an optional binder, and pores occupying 1% to 40% by volume of the cathode active layer, and introducing a first interface enhancer composition into the pores; (b) Combining an anode, a layer of solid-state electrolyte, the cathode, and a protective housing to form a cell; and (c) Conducting electrochemical formation of the cell by charging and discharging the cell at least one cycle, optionally removing formation-induced gaseous species from the cell, sealing the cell, and/or compression the cell to produce the rechargeable lithium cell. Compression of the cell may be conducted by using roll-pressing, hot/cold press compression, etc.

To produce an electrode (e.g., a cathode as in step (a)), an active material (e.g. cathode active material particles, such as NCM, NCA and lithium iron phosphate), a conducting additive (e.g. carbon black, carbon nanotubes, expanded graphite flakes, or graphene sheets), and an optional flame-retardant agent and/or optional particles of an inorganic solid electrolyte may be mixed to form a slurry or paste. The slurry or paste is then made into a desired electrode shape (e.g. cathode electrode), possibly supported on a surface of a current collector (e.g. an Al foil as a cathode current collector). The resulting cathode layer typically has a porosity level of up to 40% by volume, but can be higher or lower. An anode of a lithium-ion cell may be made in a similar manner using an anode active material (e.g. particles of graphite, Si, SiO, etc.).

The interface enhancer composition may be introduced into the pores of the cathode active layer via spraying, coating casting, printing, painting the interface enhancer onto a surface of the cathode layer or by dipping the cathode layer into the interface enhancer composition.

In some embodiments, this procedure of introducing into pores of a cathode layer, into pores of an anode layer (or onto surfaces of an anode layer), and/or a solid-state electrolyte may be accomplished by at least one of the following procedures:
(a1) impregnating a liquid solution of an organic solvent and a lithium salt dissolved therein into pores of the cathode (e.g., by spraying, coating, or printing the liquid solution onto the cathode active layer surface or immersing the cathode active layer in the liquid solution), allowing the liquid solution to permeate into pores and then partially or completely removing the organic solvent, leaving behind lithium salt precipitated out in the pores;
(a2) impregnating a liquid solution of an ionic liquid and a lithium salt dissolved therein into pores of the cathode (e.g., by spraying, coating, or printing the liquid solution onto the cathode active layer surface or immersing the cathode active layer in the liquid solution), allowing the liquid solution to permeate into pores;
(a3) impregnating a polymer solution, consisting of an organic solvent, a polymer and a lithium salt dissolved in the organic solvent, into pores of the cathode (e.g., by spraying, coating, or printing the polymer solution onto the cathode active layer surface or immersing the cathode active layer in the liquid solution), allowing the polymer solution to permeate into pores and then partially or completely removing the organic solvent, leaving behind lithium salt and the polymer precipitated out in the pores, wherein the lithium salt is dispersed in the polymer; and
(a4) impregnating a reactive polymer precursor solution, comprising a monomer, an oligomer, an initiator and/or a cross-linking agent, and a lithium salt dissolved in the precursor solution, into pores of the cathode (e.g., by spraying, coating, or printing the polymer solution onto the cathode active layer surface or immersing the cathode active layer in the liquid solution), allowing the polymer solution to permeate into pores and then polymerizing and/or crosslinking the precursor solution.

The interface enhancer composition is designed to permeate into the internal structure of the cathode and to be in physical contact or ionic contact with substantially all particles of the cathode active material in the cathode, and to permeate into the anode electrode to be in physical contact or ionic contact with the anode active material where/if present. A compression or pressure can help the permeation of the interface enhancer composition (when still containing some liquid ingredient) into pores and making contact with all cathode and/or anode active materials.

In some embodiments, the layer of solid-state electrolyte in step (b) is preloaded (e.g., pre-impregnated or pre-coated) with a second interface enhancer composition which is identical to or different than the first interface enhancer composition. This preloading procedure may be conducted by a procedure analogous to one of the aforementioned (a1), (a2), (a3), and (a4).

The anode electrode, a cathode electrode, and the enhancer-preloaded solid-state electrolyte, along with a protective housing, are then combined to form a battery cell.

The disclosure further provides a method of producing the rechargeable lithium cell, the method comprising: (A) Mixing particles of a cathode active material, an optional conductive additive, and an optional binder to form a cathode active layer optionally supported on a cathode current collector, wherein the cathode active layer has pores; (B) providing an anode and a solid-state electrolyte layer, wherein at least one of the anode, the cathode active layer, and the solid-state electrolyte layer is preloaded with a first interface enhancer composition; and (C) combining the cathode, the solid-state electrolyte layer, the anode, and a protective housing to form the rechargeable lithium cell.

The anode may be prepared by combining an anode active material, an optional conductive additive, and an optional binder to form an anode active layer optionally supported on an anode current collector, wherein the anode active layer comprises pores to accommodate an interface enhancer composition.

In some embodiments, step C) further comprises an electrochemical formation procedure, a gas removal procedure, a cell compression procedure, or a combination thereof.

The method may further comprise adding 0.1% to 30% by weight of particles of an inorganic solid electrolyte powder in the cathode or in the anode.

In some embodiments, the interface enhancer composition comprises a polymerizable or cross-linkable liquid containing a lithium salt dissolved therein, and the method further comprises polymerizing or cross-linking this liquid in the anode, the solid-state electrolyte, or the cathode before, during, or after step C).

The polymerizable or cross-linkable liquid may be selected from acrylate, allyl, and vinyl ether monomers or oligomers, vinyl ethylene carbonate (VEC), vinylene carbonate (VC), acrylate or methyl acrylate, fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl) imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, trimethylene carbonate (TMC), Glyme, organic compounds with epoxy group, —NH₂ group or SH group, or a combination thereof.

The procedure of polymerizing and/or crosslinking may comprise exposing the reactive additive to heat, UV, high-energy radiation, or a combination thereof. The high-energy radiation may be selected from electron beam, Gamma radiation, X-ray, neutron radiation, etc. Electron beam irradiation is particularly useful.

These and other advantages and features of the present invention will become more transparent with the description of the following best mode practice and illustrative examples.

### BRIEF DESCRIPTION OF THE DRAWINGS

FIG. 1 A process flow chart to illustrate a method of producing a lithium metal battery comprising a substantially solid-state electrolyte according to some embodiments of the present disclosure.

FIG. 2(A) Structure of an anode-less lithium metal cell (as manufactured or in a discharged state) according to some embodiments of the present disclosure;

FIG. 2(B) Structure of an anode-less lithium metal cell (in a charged state) according to some embodiments of the present disclosure.

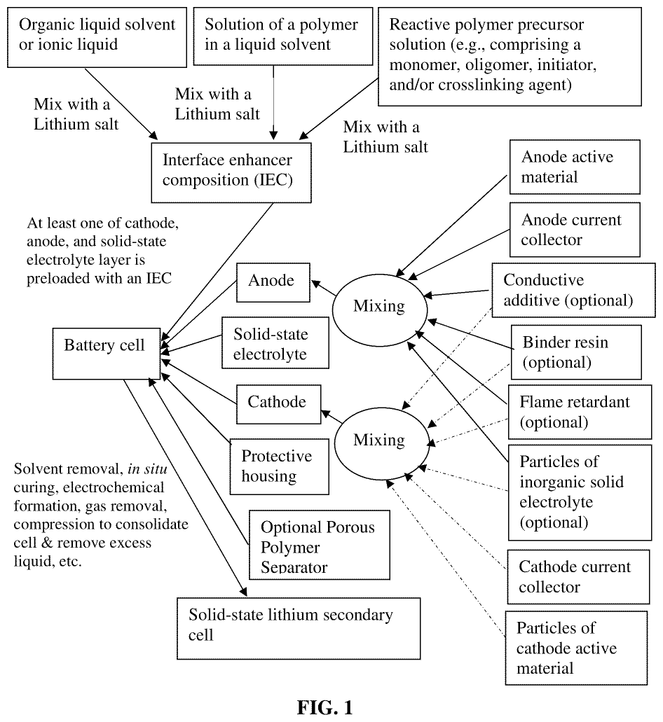

### DETAILED DESCRIPTION

The present disclosure provides a safe and high-performing lithium battery, which can be any of various types of lithium-ion cells or lithium metal cells. A high degree of safety is imparted to this battery by a novel and unique electrolyte that is highly flame-resistant and would not initiate a fire or sustain a fire and, hence, would not pose explosion danger. This disclosure has solved the very most critical issue that has plagued the lithium-metal and lithium-ion industries for more than three decades. This disclosure also solves the large interfacial and internal impedance problem of all the solid-state batteries.

As indicated earlier in the Background section, a strong need exists for a safe, non-flammable rechargeable lithium cell that is compatible with existing battery production facilities. It is well-known in the art that solid-state electrolyte battery typically cannot be produced using existing lithium-ion battery production equipment or processes.

The present disclosure provides a rechargeable lithium battery comprising an anode, a cathode, a solid-state electrolyte disposed between the anode and the cathode, at least an interface enhancer composition in ionic communication with the anode and the cathode, and an optional porous polymer separator, wherein: (a) the solid-state electrolyte comprises a solid polymer electrolyte, a polymer gel electrolyte, an inorganic solid-state electrolyte, or a polymer/inorganic composite electrolyte, wherein the solid-state electrolyte has a lithium-ion conductivity no less than 10⁻⁶ S/cm, preferably from 10⁻⁵ to 3.5×10⁻² S/cm; (b) the interface enhancer composition comprises a lithium salt, a liquid solution comprising an organic solvent or ionic liquid and a lithium salt (0.1% to 50% by weight) dissolved or dispersed therein, a polymer containing a lithium salt (0.1% to 50% by weight) dissolved or dispersed therein, or a combination thereof; (c) the cathode comprises a cathode active layer comprising particles of a cathode active material, a conductive additive, an optional binder, and pores occupying 1% to 40% by volume of the cathode active layer and the interface enhancer resides in 30% to 100% of the pores; and (d) a first interface enhancer composition is present between the solid-state electrolyte and the cathode and a second interface enhancer composition is present between the solid-state electrolyte and the anode, wherein the first is identical to or different from the second interface enhancer composition.

The first interface enhancer composition is preferably selected from those having a higher resistance to electrochemical oxidation (preferably stable above 4.2 V relative to Li/Li⁺, further preferably stable above 4.5 V). The second interface enhancer composition is preferably selected from those having a higher resistance to electrochemical reduction (preferably stable below 1.0 V, further preferably stable below 0.5 V, and most preferably below 0.2 V relative to Li/Li⁺).

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The disclosed battery can function well with or without this optional porous polymer separator; e.g., porous polyethylene (PE), polypropylene (PP), PE/PP copolymer membrane, etc. The solid-state electrolyte disposed between the anode and the cathode serves effectively as a separator that electronically isolates the anode from the cathode. The solid-state electrolyte can have pores to accommodate the interface enhancer composition or can be pore-free provided that it has a lithium-ion conductivity greater than 10⁻⁶ S/cm (preferably from 10⁻⁵ S/cm to 3.5×10⁻² S/cm).

In certain embodiments, the anode comprises an anode active layer comprising particles of an anode active material, a conductive additive, an optional binder, and pores occupying 1% to 40% by volume of the anode active layer and the interface enhancer resides in 30% to 100% of the pores.

In some embodiments, the anode comprises initially an anode current collector only (i.e. a so-called “anode-less lithium cell”) or comprises a lithium metal or lithium alloy layer supported on an anode current collector (e.g., a lithium metal cell). It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.)

The presently disclosed battery features an electrolyte that is a substantially solid-state electrolyte that has the following highly desirable and advantageous features: (i) good solid electrolyte-electrode contact and interfacial stability (minimal solid electrode-electrolyte interfacial impedance) commonly enjoyed by a liquid electrolyte; (ii) good processibility and ease of battery cell production; (iii) highly resistant to flame and fire.

In some preferred embodiments, the interface enhancer composition or the solid-state electrolyte further comprises a flame retardant additive. The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

Flame-retardant additives are intended to inhibit or stop polymer pyrolysis and combustion processes by interfering with the various mechanisms involved-heating, ignition, and propagation of thermal degradation.

There is no limitation on the type of flame retardant that can be physically or chemically incorporated into the elastic polymer. The main families of flame retardants are based on compounds containing: Halogens (Bromine and Chlorine), Phosphorus, Nitrogen, Intumescent Systems, Minerals (based on aluminum and magnesium), and others (e.g. Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). For instance, reactive polysiloxane can chemically react with EPDM type elastic polymer and become part of the crosslinked network polymer. It may be noted that flame-retarding group modified polysiloxane itself is an elastic polymer composite containing a flame reatardant according to an embodiment of instant disclosure. Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates).
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organo-halogen and organophosphate compounds also do not react permanently to attach themselves into the polymer. Certain new non halogenated products, with reactive and non-emissive characteristics have been commercially available as well.

In certain embodiments, the flame retardant additive is in a form of encapsulated particles comprising the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material. The encapsulating or micro-droplet formation processes that can be used to produce protected flame-retardant particles are well-known in the art of medicine capsules (e.g., spray-drying).

In a highly desirable embodiment, the interface enhancer composition comprises a lithium salt or a liquid solution comprising an ionic liquid, or an organic solvent, and a lithium salt dissolved or dispersed therein, and wherein the interface enhancer composition forms a contiguous phase or a continuous lithium ion pathway from the cathode active material through the solid-state electrolyte to the anode.

In some embodiments, the ionic liquid in the interface enhancer composition is selected from a room temperature ionic liquid having a cation preferably selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI](n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylimidazolium bis(trifluoromethylsulfonyl) imide ([EMIM][TFSI]), 1-Ethyl-3-methylimidazolium trifluoromethanesulfonate ([EMIM][Tf]) and 1-Butyl-3-methylimidazolium dicyanamide ([BMIM][DCA]), or a combination thereof.

The ionic liquid in the interface enhancer composition may be selected from a room temperature ionic liquid having an anion selected from BF₄, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

In certain embodiments, the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof. Preferably, the liquid or the polymer in the interface enhancer composition comprises a lithium salt of 0.1%-50% by weight dispersed therein.

Most of these liquids are polymerizable or cross-linkable; e.g., those organic compounds containing unsaturated C═C bonds, cyclic carbonates, cyclic esters, cyclic ethers, and combinations thereof. In the lithium-ion battery or lithium metal battery industry, the liquid solvents listed above are commonly used as a solvent to dissolve a lithium salt therein and the resulting solutions are used as a liquid electrolyte. It is uniquely advantageous to be able to polymerize the liquid solvent once injected into an anode, a cathode, a solid-state electrolyte, or a battery cell, enabling the formation of a contiguous lithium salt-containing solid polymer phase. With such a novel strategy, one can readily reduce the liquid solvent or completely eliminate the liquid solvent all together. This is of significant utility value since most of the organic solvents are known to be volatile and flammable, posing a fire and explosion danger.

Desirable liquid solvents include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

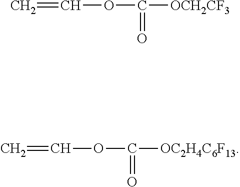

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

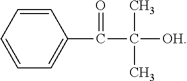

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively (all polymerizable via ring-opening polymerization with an ionic initiator) are shown below:

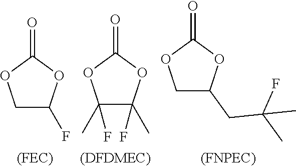

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

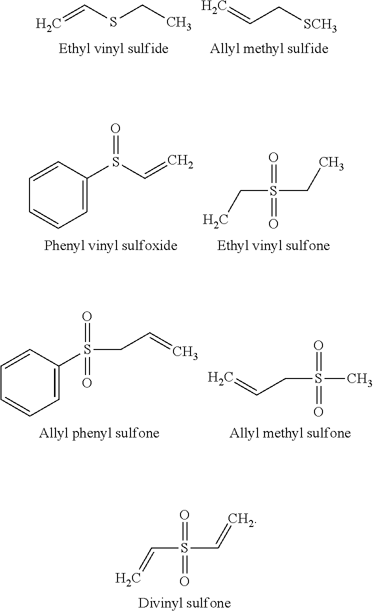

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant. Some examples are difunctional β-allyl sulfones and 4,4¢-(m-phenylene-dioxy)bis(benzenesulfonyl chloride):

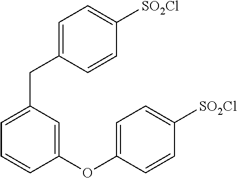 [SMILES: O=S(=O)(Cl)c1ccc(Cc2cccc(Oc3ccc(S(=O)(=O)Cl)cc3)c2)cc1]

Bisphenol S (BPS) and 4,4′-Dih orodiphenyl sulfone (DCDPS) are additional examples that can be a part of a polymer structure. Bisphenol S (BPS) is an organic compound with the formula (HOC₆H a)₂SO₂:

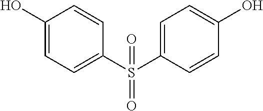 [SMILES: O=S(=O)(c1ccc(O)cc1)c1ccc(O)cc1]

4,4′-Dichlorodiphenyi sulfone (DCDPS), having a MP=148° C. is an organic compound with the formula (ClC₆H₄)₂SO₂:

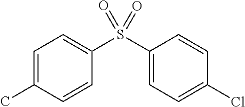 [SMILES: Cc1ccc(S(=O)(=O)c2ccc(Cl)cc2)cc1]

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

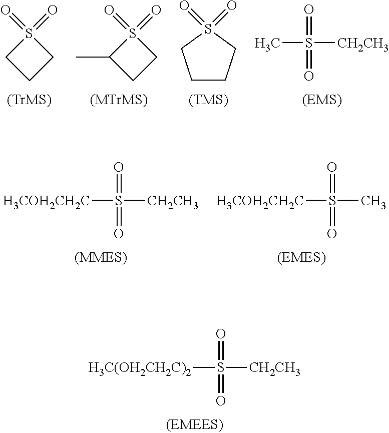

The cyclic structure, such as TrMS, MTrMS, and TMS, can be polymerized via ring-opening polymerization with the assistance of an ionic type initiator.

The nitrile may be selected from AND, GLN, SEN, SN, or a combination thereof and their chemical formulae are given below:

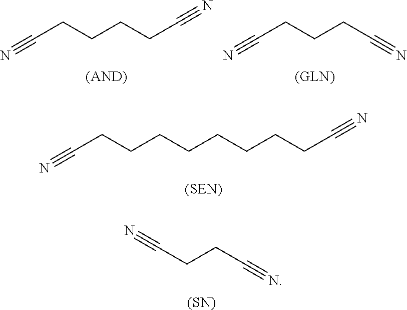

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

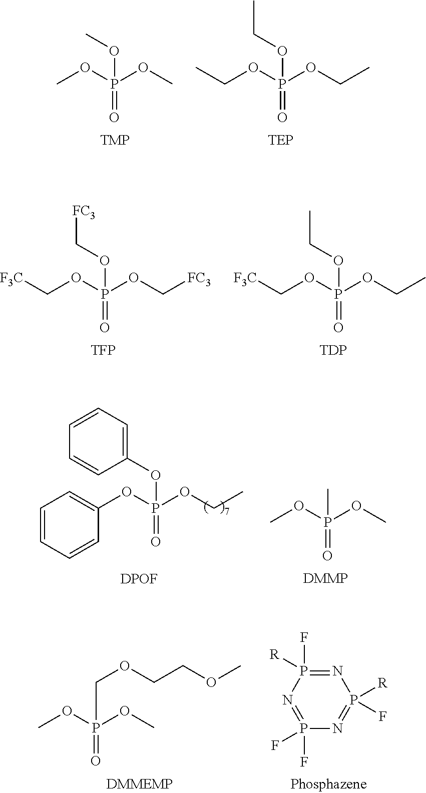

wherein R═H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

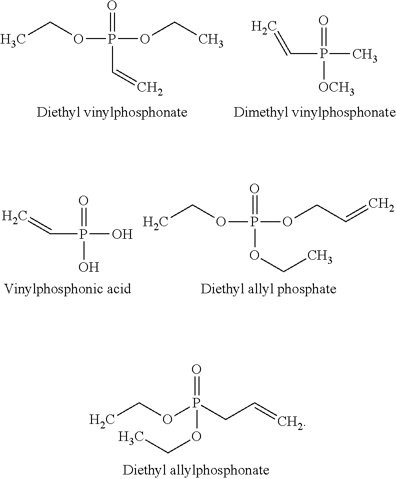

Examples of a polymerizable phosphazene contain derivatives with a general structural formula:

[—NP(A)ₐ(B)_{b}-]ₓ
wherein the groups A and B are bonded to phosphorus atoms through —O—, —S—, —NH—, or —NR— (with R═C₁-C₆) alkyl), and wherein A stands more precisely for a vinyl ether group or a styrene ether group, and B stands more precisely for a hydrocarbon group. In general, A contains at least one vinyl ether group of the general formula Q-O—CR′═CHR″ and/or styrene ether group of the general formula:

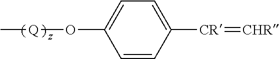

wherein R′ and/or R″ stands for hydrogen or C₁-C₁₀ alkyl; B stands for a reactive or nonreactive hydrocarbon group optionally containing O, S, and/or N, and optionally containing at least one reactive group; Q is an aliphatic, cycloaliphatic, aromatic, and/or heterocyclic hydrocarbon group, optionally containing O, S, and/or N: a is a number greater than 0; b is 0 or a number greater than 0 and a+b=2; x stands for a whole number that is at least 2; and z stands for 0 or 1. Initiators for these phosphazene derivatives can be those of Lewis acids, SbCl₃, AlCl₃, or sulfur compounds.

Examples of initiator compounds that can be used in the polymerization of vinylphosphonic acid are peroxides such as benzoyl peroxide, toluy peroxide, di-tert.butyl peroxide, chloro benzoyl peroxide, or hydroperoxides such as methylethyl ketone peroxide, tert, butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si—O), alkyylsilane (Si—C), liquid oligomeric silaxane (—Si—O—Si—), or a combination thereof.

The polymerizable liquid may further comprise an amide group selected from N,N-dimethylacetamide, N,N-diethylacetamide, N,N-dimethylformamide, N,N-diethyiformamide, or a combination thereof.

The crosslinking agent may comprise a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethiyleneglycoldirnethacrylate, poly(diethawol) dinethiylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 2:

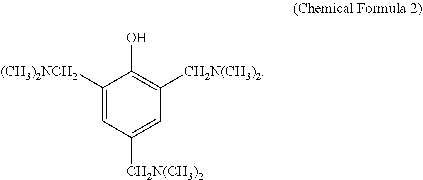

In the rechargeable lithium battery, the polymerizable liquid may further comprise a chemical species represented by Chemical Formula 3 or a derivative thereof and the crosslinking agent comprises a chemical species represented by Chemical Formula 4 or a derivative thereof:

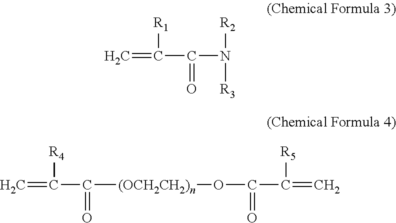

where R₁ is hydrogen or methyl group, and R₂ and R₃ are each independently one selected from the group consisting of hydrogen, methyl, ethyl, propyl, dialkylaminopropyl (—C₃ H₆ N(R′)₂) and hydroxyethyl (CH₂ CH₂ OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent may be selected from N,N-methylene bisacrylamide, epichlorohydrin. 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PC)₄)₃ is very low, but can be improved by the substitution of Hf or Sn. This can be further enhanced with substitution to form Li₁₊ₓNMₓTi₂₋ₓ(PO₄)₃(M=Al, Cr, Ga, Fe, Sc, In, Lu, Y or La). Al substitution has been demonstrated to be the most effective solid-state electrolyte. The Li₁₊ₓAlₓGe₂₋ₓ (PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and six-fold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M Nb or Ta), Li_{5.5}La₃M_{1.75}B_{0.25}O₁₂ (M=Nb or Ta; B═In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LIS ICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

Sulfide-type SSEs that have been successfully synthesized include the LPS class, Li₂S—SiS₂ system, Li₆PS₅X (X═Cl, Br, I, and combinations thereof), and LiₓMP_{y}S_{z} (M=Ge, Sn, Si, Al, and combinations thereof) bases. The lithium thiophosphate or LPS class consists of several high-conducting materials. Several sulfide crystalline phases have been found, of which the type of crystal formed depends on the heat treatment applied and the composition of the glass formed. The sulfide crystalline phases include: Li₃PS₄, Li₇P₃S₁₁, Li₇PS₆ and Li₄P₂S₆. The derivatives of Li₆PS₅X include Li_{6-y}PS_{5-y}Cl_{1+y}, Li_{6-y}PS_{5-y}Br_{1+y}, and Li_{6-y}PS_{5-y}I_{1+y} (with y=0-0.5), etc. Examples of LiₓMP_{y}S_{z} (M=Ge, Sn, Si, Al, and combinations thereof) include Li₁₀GeP₂S₁₂, Li₁₀SnP₂S₁₂, Li₁₀SiP₂S₁₂, and Li₁₁AlP₂S₁₂, Li₁₀Si_{0.3}Sn_{0.7}P₂S₁₂, etc. The particles of all these sulfide-type inorganic electrolytes may be used in the presently disclosed composite particulates.

These inorganic solid electrolyte (ISE) particles embedded in a polymer matrix can help enhance the lithium ion conductivity. Preferably and typically, the polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by embedding the ISE particles in a polymer electrolyte that typically has a significantly wider electrochemical stability window (e.g., can be from 0 to 4.5 V relative to Li/Li⁺). The polymer protection also enables the ISEs processible using the current lithium-ion cell production processes.

These solid electrolyte particles dispersed in an electrolyte polymer can help enhance the lithium ion conductivity of certain polymers otherwise having an intrinsically low ion conductivity. Preferably and typically, the polymer has a lithium ion conductivity no less than 10⁻⁵ S/cm, more preferably no less than 10⁻⁴ S/cm, further preferably no less than 10⁻³ S/cm, and most preferably no less than 10⁻² S/cm.

In some embodiments, the polymer/inorganic composite electrolyte comprises particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The solid-state electrolyte may comprise a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphite, polyphosphonate, polyphosphazenes, polytetrahydrofuran, a copolymer thereof, a semi-penetrating network thereof, a sulfonated derivative thereof, or a combination thereof.

The disclosed lithium battery can be a lithium-ion battery or a lithium metal battery, the latter having lithium metal as the primary anode active material. The lithium metal battery can have lithium metal implemented at the anode when the cell is made. Alternatively, the lithium may be stored in the cathode active material and the anode side is lithium metal-free initially. This is called an anode-less lithium metal battery.

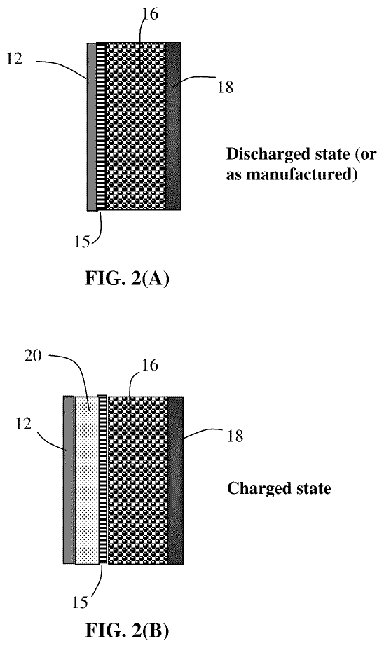

As illustrated in FIG. 2(A), the anode-less lithium cell is in an as-manufactured or fully discharged state according to certain embodiments of the present disclosure. The cell comprises an anode current collector 12 (e.g., Cu foil), a solid-state electrolyte layer 15, a cathode active layer 16 comprising a cathode active material, an optional conductive additive (not shown), an optional resin binder (not shown), and an interface enhancer composition (residing in the pores of the entire cathode layer and in contact with the cathode active material), and a cathode current collector 18 that supports the cathode layer 16. There is no lithium metal in the anode side when the cell is manufactured. However, there is a thin layer of interface enhancer composition being present between the anode current collector and the solid-state electrolyte layer.

In a charged state, as illustrated in FIG. 2(B), the cell comprises an anode current collector 12, lithium metal 20 plated on a surface (or two surfaces) of the anode current collector 12 (e.g., Cu foil), a solid-state electrolyte layer 15, a cathode active layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector. There is a thin layer of interface enhancer composition being present between the lithium metal layer and the solid-state electrolyte layer.

One unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode may only contain a current collector or a protected current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities must be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may comprise graphene balls and/or graphene foam. Preferably, the graphene layer has a thickness from 1 nm to 50 μm and/or has a specific surface area from 5 to 1000 m²/g (more preferably from 10 to 500 m²/g).

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In addition to the non-flammability and high lithium ion transference numbers, there are several additional benefits associated with using the presently disclosed solid-state batteries. As one example, a combination of a solid-state electrolyte and an interface enhancer composition properly disposed inside a cathode active layer and/or anode active layer, and disposed between a solid-state electrolyte layer and an electrode (anode or cathode) can significantly enhance cycling and safety performance of rechargeable lithium batteries through effective suppression of lithium dendrite growth. Due to a good contact between the electrolyte and an electrode, the interfacial impedance can be significantly reduced. These reasons, separately or in combination, are believed to be responsible for the notion that no dendrite-like feature has been observed with any of the large number of rechargeable lithium cells that we have investigated thus far.

As another benefit example, this combination of solid-state electrolyte and an interface enhancer composition in the cathode is capable of inhibiting diffusion of lithium polysulfide from the cathode, through the solid-state electrolyte layer and to the anode of a Li—S cell, thus overcoming the polysulfide shuttle phenomenon and allowing the cell capacity not to decay significantly with time. Consequently, a coulombic efficiency nearing 100% along with long cycle life can be achieved.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The ionic liquid is composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used alone or as a co-solvent (not as a salt) to work with the an organic solvent of the present invention. A well-known ionic liquid is formed by the combination of a 1-ethyl-3-methyl-imidazolium (EMI) cation and an N,N-bis(trifluoromethane)sulphonamide (TFSI) anion. This combination gives a fluid with an ionic conductivity comparable to many organic electrolyte solutions, a low decomposition propensity and low vapor pressure up to −300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application.

Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are also no particular restrictions on the types of cathode active materials that can be used in the presently disclosed lithium battery (lithium-ion or lithium metal battery), which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LixV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there must be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<l, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNipCoi_pO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there must be a lithium source implemented in the cathode side to begin with.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly[methanetetryl-tetra(thiomethylene)](PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that consist of conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene](PTKPTB) have a polyphenylene main chain, linking thiolane on benzene moieties as pendants. Similarly, poly[3,4(ethylenedithio)thiophene](PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there must be a lithium source implemented in the cathode side to begin with.

The present disclosure also provides a method of producing the disclosed rechargeable lithium cell, the method comprising: (a) Preparing a cathode comprising a cathode active layer optionally supported on a cathode current collector, wherein the cathode active layer comprises particles of a cathode active material, a conductive additive, an optional binder, and pores occupying 1% to 40% by volume of the cathode active layer, and introducing a first interface enhancer composition into the pores; (b) Combining an anode, a layer of solid-state electrolyte, the cathode, and a protective housing to form a cell; and (c) Conducting electrochemical formation of the cell by charging and discharging the cell at least one cycle, optionally removing electrochemical formation-induced gaseous species from the cell, compression the cell, and/or sealing the cell to produce the rechargeable lithium cell. Compression of the cell may be conducted by using roll-pressing, hot/cold press compression, etc. Compression is preferably conducted after the electrochemical formation procedure to help remove any gaseous species and excess liquid present in the interface enhancer composition.

In this method, step (a) may be selected from any commonly used cathode production process. For instance, the process may include (i) mixing particles of a cathode active material, a conductive additive, an optional resin binder, optional particles of a solid inorganic electrolyte powder, and an optional flame retardant in a liquid medium (e.g., an organic solvent, such as NMP, acetone, DMAc, etc.) to form a slurry; and (ii) coating the slurry on a cathode current collector (e.g., an Al foil) and removing the solvent to form a cathode active layer having pores. This is accompanied or followed by a procedure of introducing a first interface enhancer composition into these pores (preferably filling in all the pores partially or fully). In some embodiments, this procedure may be accomplished by at least one of the following procedures:
(a1) impregnating a liquid solution of an organic solvent and a lithium salt dissolved therein into pores of the cathode (e.g., by spraying, coating, or printing the liquid solution onto the cathode active layer surface or immersing the cathode active layer in the liquid solution), allowing the liquid solution to permeate into pores and then partially or completely removing the organic solvent, leaving behind lithium salt precipitated out in the pores;
(a2) impregnating a liquid solution of an ionic liquid and a lithium salt dissolved therein into pores of the cathode (e.g., by spraying, coating, or printing the liquid solution onto the cathode active layer surface or immersing the cathode active layer in the liquid solution), allowing the liquid solution to permeate into the pores;
(a3) impregnating a polymer solution, consisting of an organic solvent, a polymer and a lithium salt dissolved in the organic solvent, into pores of the cathode (e.g., by spraying, coating, or printing the polymer solution onto the cathode active layer surface or immersing the cathode active layer in the liquid solution), allowing the polymer solution to permeate into pores and then partially or completely removing the organic solvent, leaving behind lithium salt and the polymer precipitated out in the pores, wherein the lithium salt is dispersed in the polymer; and
(a4) impregnating a reactive polymer precursor solution, comprising a monomer, an oligomer, an initiator and/or a cross-linking agent, and a lithium salt dissolved in the precursor solution, into pores of the cathode (e.g., by spraying, coating, or printing the polymer solution onto the cathode active layer surface or immersing the cathode active layer in the liquid solution), allowing the polymer solution to permeate into the pores and then polymerizing and/or crosslinking the precursor solution.

In some ernbodirnents, the layer of solid-state electrolyte in step (b) is preloaded with a second interface enhancer composition which is identical to or different than the first interface enhancer composition. This preloading procedure may be conducted by a procedure analogous to one of the aforementioned (a1), (a2), (a3), and (a4).

The anode in step (b) may be produced in a similar manner, but using particles of an anode active material (e.g., particles of Si, SiO, Sn, SnO₂, graphite, and carbon). The liquid medium used in the production of an anode may be water or, preferably, an organic solvent.

Step (b) may entail combining the anode, a solid-state electrolyte, the cathode, along with their respective current collectors, to form a unit cell which is enclosed in a protective housing to form a cell.

The disclosure further provides a method of producing the rechargeable lithium cell, the method comprising: (A) Mixing particles of a cathode active material, an optional conductive additive, and an optional binder to form a cathode active layer optionally supported on a cathode current collector, wherein the cathode active layer has pores; (B) providing an anode and a solid-state electrolyte layer, wherein at least one of the anode, the cathode active layer, and the solid-state electrolyte layer is preloaded with a first interface enhancer composition; and (C) combining the cathode, the solid-state electrolyte layer, the anode, and a protective housing to form the rechargeable lithium cell. Again, the interface enhancer composition may be preloaded into or onto the anode, the cathode active layer, and/or the solid-state electrolyte layer by using at least one of the aforementioned (a1), (a2), (a3), and (a4) procedures.

The anode may be prepared by combining an anode active material, an optional conductive additive, and an optional binder to form an anode active layer optionally supported on an anode current collector, wherein the anode active layer comprises pores to accommodate an interface enhancer composition.

In some embodiments, step C) further comprises an electrochemical formation procedure, a gas removal procedure, a cell compression procedure, or a combination thereof.

The method may further comprise adding 0.1% to 30% by weight of particles of an inorganic solid electrolyte powder in the cathode or in the anode.

In some embodiments, the interface enhancer composition comprises a polymerizable or cross-linkable liquid containing a lithium salt dissolved therein, and the method further comprises polymerizing or cross-linking this liquid in the anode, the solid-state electrolyte, and/or the cathode before, during, or after step C). The procedure of polymerizing and/or crosslinking may comprise exposing the reactive additive to heat, UV, high-energy radiation, or a combination thereof. The high-energy radiation may be selected from electron beam, Gamma radiation, X-ray, neutron radiation, etc. Electron beam irradiation is particularly useful.

In some embodiments, step (A) further comprises adding particles of an inorganic solid electrolyte powder in the cathode. Step (B) may further comprise adding particles of an inorganic solid electrolyte powder in the anode.

The following examples are presented primarily for the purpose of illustrating the best mode practice of the present invention, not to be construed as limiting the scope of the present invention.

### Example 1: Preparation of Inorganic Solid Electrolyte (ISE) Powder, Lithium Nitride Phosphate Compound (LIPON)

Particles of Li₃PO₄ (average particle size 4 m) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃₋₆(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 5: Ionic Liquid Solvated Lithium Salts as Interfacial Enhancer Compositions

The ionic liquids used in the present study included 1-Ethyl-3-methylimidazolium bis(trifluoromethylsulfonyl)imide ([EMIM][TFSI]), 1-Ethyl-3-methylimida-zolium trifluoromethanesulfonate ([EMIM][Tf]) and 1-Butyl-3-methylimidazolium dicyanamide ([BMIM][DCA]), which were all dried for 72 h at 80° C. under vacuum:

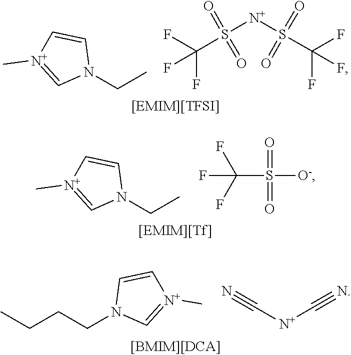

The water content was reduced to be below 10 ppm, as measured by coulometric Karl-Fischer titration. Lithium salts used included Lithium bis(trifluoromethylsulfonyl)imide (LiTFSI), Lithium trifluoromethanesulfonate (LiTf), lithium hexafluoroborate (LiBF₄), lithium nitrate (LiNO3) and lithium hexafluorophosphate (LiPF₆), which were dried under vacuum. All chemicals were stored in an argon-filled glove box.

Several ionic liquid-lithium salt combinations were prepared for use as interface enhancer compositions: 1.5M of LiTFSI, 1.0M of LiPF₆, and 1.0M of LiBF₄ dissolved in [EMIM][TFSI]; 0.6M of LiNO₃ in [EMIM][Tf]; 0.7 M of LiTf, and 0.6 M of LiPF₆ in [EMIM][Tf]. We have discovered that these ionic liquid-lithium salt systems worked very well with the polymer/inorganic solid composite electrolytes.

### Example 6: Lithium-Ion Cells Featuring an In Situ Polymerized FVC and PEGDA as an Interface Enhancer Composition (IEC) in the Anode, a Solid-State Electrolyte Layer, a Cathode and the Interface Zones Between these Components

In one example, fluorinated vinylene carbonate (FVC) and poly(ethylene glycol) diacrylate (PEGDA) were stirred under the protection of argon gas until a homogeneous solution was obtained. Subsequently, lithium hexafluoro phosphate was then added and dissolved in the above solution to obtain a reactive mixture solution (a precursor interface enhancer composition), wherein the weight fractions of fluorinated vinylene carbonate, poly(ethylene glycol) diacrylate, and lithium hexafluoro phosphate were 85 wt %, 10 wt %, and 5 wt %, respectively.

A solid-state composite electrolyte layer was made that was composed of particles of Li₇La₃Zr₂O₁₂ embedded in a polyvinylidene fluoride matrix (inorganic solid electrolyte/PVDF ratio=6/4). A carbon/SiOₓ-based anode was prepared by mixing SiOₓ particles, 5% Super-P conductive additive, and 5% PVDF dispersed in NMP to form a slurry, which was coated on a Cu foil surface and dried to form a porous anode. A cathode active layer comprising LiCoO₂ particles as the anode active material and supported on an Al foil was prepared in a similar manner. Both the anode and the cathode were then immersed in the precursor interface enhancer composition. The IEC-preloaded anode, the composite solid-state electrolyte layer, and the IEC-preloaded cathode were then stacked and laminated inside a protective housing. The cell was then irradiated with electron beam at room temperature until a total dosage of 40 Gy was reached. In-situ polymerization of the polymerizable liquid solvent in the battery cell was accomplished. The cell was electrochemically formed for 3 charge-discharge cycles, degassed, compressed, and re-sealed to form the lithium-ion cell.

### Example 7: Lithium-Ion Cell Featuring an In Situ Polymerized Phenyl Vinyl Sulfide as an Interface Enhancer Composition in Both the Anode and the Cathode

The lithium-ion cells prepared in this example comprise an anode comprising meso-carbon micro-beads (MCMB, an artificial graphite supplied from China Steel Chemical Co. Taiwan) as an anode active material. The process for producing the anode active layer having pores was similar to that used in Example 6. The cathode, comprising NCM-622 particles as a cathode active material, was prepared using a slurry coating process as described in Example 2. The cathode active layer also had pores after removal of the NNIP solvent.

Phenyl vinyl sulfide, CTA (chain transfer agent, shown below), AIBN (initiator, 1.0%), and 5% by weight of lithium trifluoro-metasulfonate (LiCF₃SO₃), were mixed to form a reactive precursor solution to the IEC. A layer of PVDF-IIFP as a solid-state electrolyte was soaked in this precursor solution for 2 hours. The resulting IEC-preloaded solid-state electrolyte layer was then sandwiched between the anode and the cathode, which was enclosed in a protective envelop and vacuum sealed to form a pouch cell. The vacuum induced compression helped to work the precursor solution into pores in the anode and pores in the cathode. A certain amount of the precursor solution was also present at the anode/PV DF-HFP and PVDF/cathode interfaces. The cell was heated at 60° C. to obtain a battery cell containing an in situ cued interface enhancer composition that bridged the gaps between the solid-state electrolyte layer and the electrodes.

The in situ curing presumably followed the following reaction:

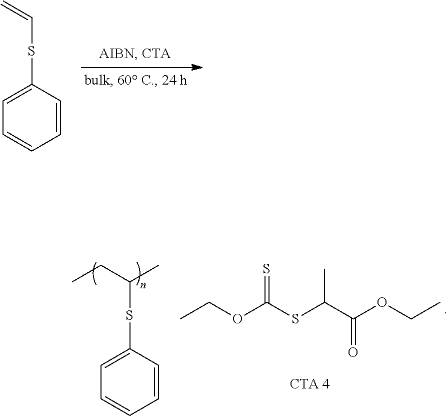

### Example 8: Solid-State Electrolytes from Poly Vinylphosphonic Acid (VPA

A natural graphite-based anode and a NCM-622 cathode, both having pores, were made, respectively, using the well-known slurry coating and drying process. An interface enhancer composition (IEC) was prepared by mixing 150 parts vinylphosphonic acid (VPA), 150 parts isopropanol, 0.75 parts benzoyl peroxide and 20 parts of lithium bis(oxalato)borate (LiBOB). Both the anode and the cathode were coated with the IEC at 60° C., allowing for permeation of the IEC into the pores. Then, most of the isopropanol was removed in a vacuum oven.

In a separate procedure, vinylphosphonic acid was heated to >45° C. (melting point of VPA=36° C.), which was added with benzoyl peroxide, LiBOB, and 50% by weight of a garnet-type solid electrolyte (Li₇La₃Zr₂O₁₂(LLZO) powder). After rigorous stirring, the resulting paste was cast onto a glass surface to form a layer of composite electrolyte. This composite solid-state electrolyte layer was disposed as a separator between an IEC-preloaded anode and an ICE-preloaded cathode layer to form a cell encased in an Al—PP laminate envelop.

The free radical polymerization of vinylphosphonic acid (VPA) was catalyzed with benzoyl peroxide as the initiator at 90° C. for 5 hours. This was followed by electrochemical formation, degassing, and compression treatments.

For the preparation of an anode-less lithium cell, a solid-state electrolyte separator layer was implemented between a Cu foil and an IEC-preloaded cathode layer.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the IEC-preloaded solid-state cells exhibit much higher capacity as compared to those without ICE. Furthermore, these cells are flame resistant and relatively safe.

### Example 9: Diethyl Vinylphosphonate and Diisopropyl Vinylphosphonate Polymer Electrolytes in a Lithium/NCM-532 Cell (Initially the Cell being Lithium-Free) and Lithium-Ion Cell Containing a Si-Based Anode and a NCM-532 Cathode

Both diethyl vinylphosphonate and diisopropyl vinylphosphonate were polymerized by a peroxide initiator (di-tert-butyl peroxide), along with LiBF₄, to clear, light-yellow polymers of low molecular weight. In a typical procedure, either diethyl vinylphosphonate or diisopropyl vinylphosphonate (being a liquid at room temperature) is added with di-tert-butyl peroxide (0.5-2% by weight) and LiBF₄ (5-10% by weight) to form a reactive solution.

For the construction of a lithium-ion cell, a graphene-coated Si particle-based anode and a NCM-532-based cathode were prepared, which were impregnated with this reaction solution (a precursor to the IEC) at 45° C. Additionally, layers of diethyl vinylphosphonate and diisopropyl vinylphosphonate polymer electrolytes were cast on glass surfaces and bulk polymerization was allowed to proceed for 2-12 hours at 55° C. After polymerization, they were removed from the glass to obtain free-standing solid-state polymer electrolyte films. An IEC-preloaded anode, a solid-state polymer film, an IEC-preloaded cathode were stacked and housed in a plastic/Al laminated envelop to form a cell. For the construction of an anode-less lithium metal cell, a Cu foil anode current collector, a free-standing polymer electrolyte film, and an IEC-preloaded NCM-532-based cathode were stacked and housed in a plastic/Al laminated envelop to form a cell. The solution was heated to 45° C. and injected into a dry battery cell. The cells were heated at 55° C. for 6 hours, followed by electrochemical formation, degassing, compression, and sealing.

In some samples, a desired amount (5% by weight based on a total electrode weight) of a flame retardant (e.g. decabromodiphenyl ethane (DBDPE), brominated poly(2,6-dimethyl-1,4-phenylene oxide) (BPPO), and melamine-based flame retardant, separately; the latter from Italmatch Chemicals) was added into the reactive mass.

In several samples, a garnet-type solid electrolyte (Li₇La₃Zr₂O₁₂(LLZO) powder) was added into the cathode (NCM-532) in the anode-less lithium battery.

### Example 10: In Situ Cured Cyclic Esters of Phosphoric Acid as an Interface Enhancer Composition (IEC) and Poly(Vinylidene Fluoride)-Hexafluoropropylene (PVDF-HFP)/LGPS Composite Solid-State Electrolyte

Flame-resistant phosphate-based polymer as an IEC ingredient may be synthesized from five-membered cyclic esters of phosphoric acid of the general formula: —CH₂CH(R)OP(O)—(OR′)O— by using n-C₄H₉Li, (C₅H₅)₂Mg, or (i-C₄H₉)₃Al as initiators. The resulting polymers have a repeating unit as follows:

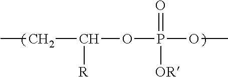

where R is H, with R′═CH₃, C₂H₅, n-C₃H₇, i-C₃H₇; n-C₄H₉, CCl₃CH₂, or C₆H₅, or R is CH₂Cl and R′ is C₂H₅. The polymers typically have Mn=10⁴-10⁵.

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′═H in the following chemical formula):

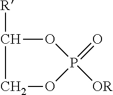

Temperature was used to adjust the viscosity of the reactant mixture, enabling the reactive solution to permeate into pores of an anode or cathode to form IEC-preloaded anode and IEC-preloaded cathode layers. The anode comprises carbon-coated SiO particles and the cathode comprises NCA particles as a cathode active material.

For the preparation of a polymer/inorganic solid-state electrolyte, PVDF-HFP was dissolvable in a liquid solvent acetone and 50% of nano particles of an inorganic solid-state electrolyte (LGPS prepared in Example 3) were added into the resulting polymer solution to form a slurry. The slurry was coated onto a glass surface with acetone subsequently removed to form polymer/LGPS payers. An IEC-preloaded anode, a polymer/LGPS layer, and an IEC-preloaded cathode were laminated and enclosed in a protective casing. The anionic polymerization of cyclic ester of phosphoric acid residing in the pores of an anode and those in a cathode was allowed to proceed at room temperature (or lower) overnight to produce a solid state cell.

1. A rechargeable lithium battery comprising an anode, a cathode, a solid-state electrolyte disposed between the anode and the cathode, and at least an interface enhancer composition in ionic communication with the anode and the cathode, wherein:
a) the solid-state electrolyte comprises a solid polymer electrolyte, a polymer gel electrolyte, an inorganic solid-state electrolyte, or a polymer/inorganic composite electrolyte, wherein the solid-state electrolyte has a lithium-ion conductivity no less than 10⁻⁶ S/cm;
b) the interface enhancer composition comprises (i) a lithium salt, (ii) a liquid solution comprising an organic solvent or ionic liquid and a lithium salt dissolved or dispersed therein, (iii) a polymer containing a lithium salt dissolved or dispersed therein, or (iv) a combination thereof;
c) the cathode comprises a cathode active layer comprising particles of a cathode active material, a conductive additive, and pores occupying 1% to 40% by volume of the cathode active layer and the interface enhancer composition resides in 30% to 100% of the pores; and
d) a first interface enhancer composition is present between the solid-state electrolyte and the cathode and a second interface enhancer composition is present between the solid-state electrolyte and the anode, wherein the first is identical to or different from the second interface enhancer composition.

2. The rechargeable lithium battery of claim 1, wherein the anode comprises an anode active layer comprising particles of an anode active material, a conductive additive, and pores occupying 1% to 40% by volume of the anode active layer and the interface enhancer resides in 30% to 100% of the pores.

3. The rechargeable lithium battery of claim 1, wherein the anode comprises an anode current collector or a lithium metal or lithium alloy layer supported on an anode current collector.

4. The rechargeable lithium battery of claim 1, wherein the interface enhancer composition or the solid-state electrolyte further comprises a flame retardant additive.

5. The rechargeable lithium battery of claim 4, wherein the flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

6. The rechargeable lithium battery of claim 1, wherein the interface enhancer composition forms a contiguous phase or a continuous lithium ion pathway from the cathode active material through the solid-state electrolyte to the anode and the interface enhancer composition is in physical contact with substantially all particles of the cathode active material.

7. The rechargeable lithium battery of claim 1, wherein the interface enhancer composition comprises (i) a lithium salt or (ii) a liquid solution comprising an ionic liquid or an organic solvent and a lithium salt dissolved or dispersed in the ionic liquid or organic solvent, and wherein the interface enhancer composition forms a contiguous phase or a continuous lithium ion pathway from the cathode active material through the solid-state electrolyte to the anode.

8. The rechargeable lithium battery of claim 1, wherein the ionic liquid in the interface enhancer composition is selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI](n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylirnidazoliurn bis(trifluoromethylsulfonyl) imide ([EMIM][TFSI]), 1-Ethyl-3-methylimidazolium trifluoronethanesulfonate ([ENMIM][Tf]) and 1-Butyl-3-methylimidazolium dicyanamide ([BMIM][DCA]), or a combination thereof.

9. The rechargeable lithium battery of claim 1, wherein the ionic liquid in the interface enhancer composition is selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

10. The rechargeable lithium battery of claim 1, wherein the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), Gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof.

11. The rechargeable lithium battery of claim 10, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

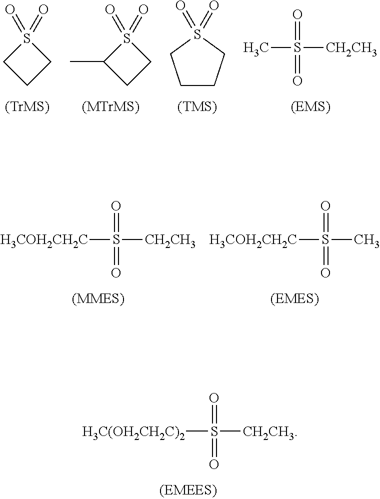

12. The rechargeable lithium battery of claim 10, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

13. The rechargeable lithium battery of claim 10, wherein the nitrile comprises a dinitrile or is selected from AND, GLN, SEN, SN, or a combination thereof:

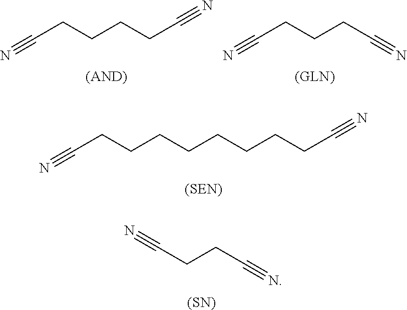

14. The rechargeable lithium battery of claim 10, wherein the phosphate is selected from allyl-type, vinyl-type, styrenic-type and (meth)acrylic-type monomers bearing a phosphonate moiety.

15. The rechargeable lithium battery of claim 10, wherein the phosphate, phosphonate, phosphonic acid, phosphazene, or phosphite is selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 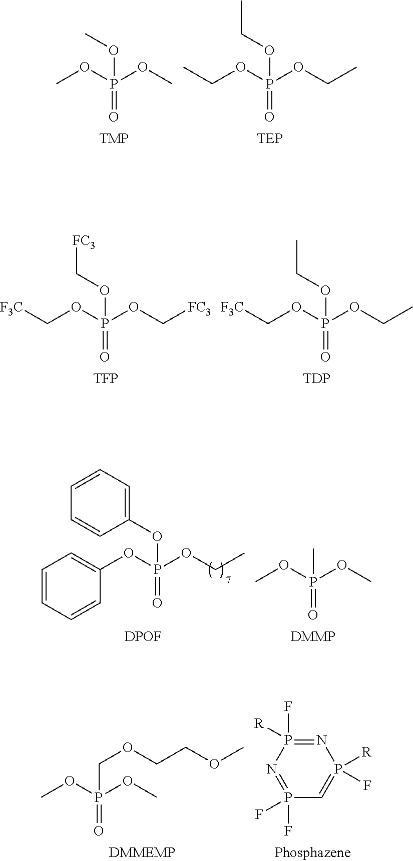
wherein R═H, NH₂, or C₁-C₆ alkyl.

16. The rechargeable lithium battery of claim 10, wherein the siloxane or silane is selected from alkylsiloxane (Si—O), alkyylsilane (Si—C), liquid oligomeric silaxane (—Si—O—Si—), or a combination thereof.

17. The rechargeable lithium battery of claim 1, wherein the inorganic solid-state electrolyte or the polymer/inorganic composite electrolyte comprises an inorganic solid electrolyte material selected from an oxide type, sulfide type, hydride type, halide type, halogen-modified sulfide type, borate type, phosphate type, lithium phosphorus oxynitride (LiPON), garnet-type, lithiumn superionic conductor (LISICON) type, sodium superionic conductor (NASICON) type, or a combination thereof.

18. The rechargeable lithium battery of claim 1, wherein the polymer/inorganic composite electrolyte comprises particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LixSO_{y}, or a combination thereof, wherein X═F, Cl, I, or Br, R=a hydrocarbon group, x=0-1, y=1-4.

19. The rechargeable lithium battery of claim 1, wherein the solid-state electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphite, polyphosphonate, polyphosphazenes, polytetrahydrofuran, a copolymer thereof, a semi-penetrating network thereof, a sulfonated derivative thereof, or a combination thereof.

20. The rechargeable lithium cell of claim 1, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

21. The rechargeable lithium battery of claim 4, wherein said flame retardant additive is in a form of encapsulated particles comprising the additive encapsulated by a shell of a substantially lithium ion-impermeable and liquid electrolyte-impermeable coating material, wherein said shell is breakable when exposed to a temperature higher than a threshold temperature

22. The rechargeable lithium battery of claim 1, wherein said polymer/inorganic composite electrolyte comprises an inorganic solid material in a fine powder form having a particle size from 2 nm to 30 μm, wherein said particles of inorganic solid material are dispersed in said polymer or chemically bonded by said polymer.

23. The rechargeable lithium cell of claim 1, which is a lithium metal secondary cell, a lithium-ion cell, a lithium-sulfur cell, a lithium-ion sulfur cell, a lithium-selenium cell, or a lithium-air cell.

24. The rechargeable lithium cell of claim 1, wherein the cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

25. The rechargeable lithium cell of claim 1, which is a lithium-ion cell wherein the anode comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles; (g) prelithiated versions thereof; and (h) combinations thereof.

26. The rechargeable lithium cell of claim 1, further including a porous polymer separator.

27. The rechargeable lithium cell of claim 1, wherein said cathode further includes a binder.

28. The rechargeable lithium cell of claim 1, wherein said anode further includes a binder.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
